(19) United States
(12) Patent Application Publication
(10) Pub. No.: US 2020/0331159 A1
(43) Pub. Date: Oct. 22, 2020

(54) RAZOR KNIFE

(71) Applicant: Sung H. Yoo, West Chester, PA (US)

(72) Inventor: Sung H. Yoo, West Chester, PA (US)

(21) Appl. No.: 16/663,513

(22) Filed: Oct. 25, 2019

Related U.S. Application Data
(60) Provisional application No. 62/834,790, filed on Apr. 16, 2019.

(51) Int. Cl. B26B 21/52; B26B 5/00; B26B 21/10

(52) U.S. Cl. CPC B26B 21/521; B26B 5/006; B26B 21/522; B26B 21/525; B26B 21/10

(57) ABSTRACT

A razor knife includes a body with a handle a blade carrier portion. The razor blade is secured between the blade carrier and a door by the mutual attraction of pair of magnets.

### BACKGROUND OF THE INVENTION

### 1. Field of the Invention

The present invention relates to barbering equipment, and in particular to razor knives.

### 3. Brief Summary of the Prior Art

Razor knives and other implements for using disposable blades are known in the art. For example, U.S. Pat. Nos. 2,840,903 and 2,960,768 disclose retractable holders for safety razor blades such that only a portion of the blade is exposed during use. In addition to safety razor blades, utility knives with replaceable blades are also known. For example, U.S. Patent Publication 2006/0117570 A1 discloses a utility knife with a cam clamp for retaining the replaceable blade in a locked position for use. U.S. Pat. No. 6,865,816 discloses a replaceable blade utility knife with a magnetic actuator. A pair of opposed magnets in either half of the knife repel each other to push open the knife so that a dull or broken blade can be replaced. There is a continuing need for an inexpensive, simple tool for holding razor blades, and in particular in the barbering arts.

### SUMMARY OF THE INVENTION

The present invention provides a razor knife comprising a body including a handle portion and a blade carrier portion and a first hinge half formed between the handle portion and the blade carrier portion. The razor knife also comprises a door including a second hinge half formed at one end of the door portion. The door extends from the body with the first hinge half and second hinge half forming a hinge. The door is rotatable between an open position and a closed position. The razor knife also includes at least one pair of magnets, a first magnet of the at least one pair being mounted in the blade carrier portion, and a corresponding second magnet of the at least one pair being mounted in the door. The first magnet and second magnet attract each other when the door is in the closed position.

Preferably, the razor knife further comprises at least one projection for securing a blade in the razor knife between the blade carrier portion and the door when the door is in the closed position. Preferably, the at least one projection is formed in the blade carrier portion. In another aspect, the at least one projection is formed in the door. In yet another aspect, at least one projection is formed in the blade carrier portion and at least one projection is formed in the door.

### BRIEF DESCRIPTION OF THE FIGURES

FIG. 1 is a persective view of a razor knife according to the present invention shown in the open position.

FIG. 2 is a side elevational view of the razor knife of FIG. 1 with a razor blade mounted in the razor knife.

FIG. 3 is a side elevational view of the razor knife of FIG. 1 shown in the closed position with a razor blade mounted in the razor knife.

### DETAILED DESCRIPTION

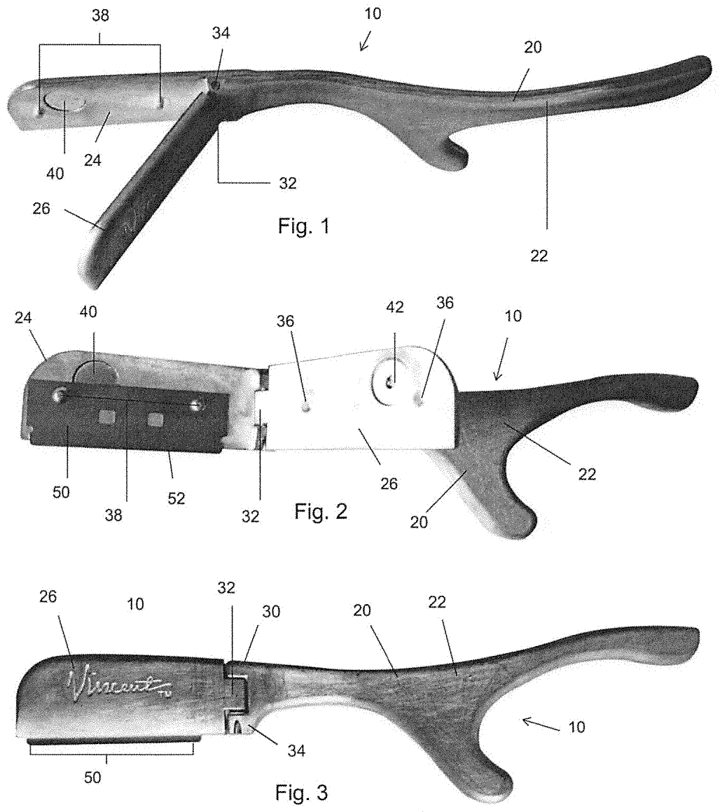

Referring now to the figures in which like reference numerals represent like elements in each of the several views, there is shown in FIG. 1 a perspective view taken from above of a first embodiment of a razor knife 10 according to the present invention. The razor knife 10 includes a one-piece base 20 formed from a suitable rigid material such as wood or a thermosetting or thermoplastic material. The base 20 includes a generally “Y”-shaped ergonomic handle portion 22 at the rear of the base 20, as well as a generally rectangular blade-holding portion 24 at the front of the base 20. The blade-holding portion 24 is sized slightly larger than the razor blade 50 the razor knife 10 is intended to receive. A first hinge portion 30 is formed in the base 20 between the handle portion 22 and the blade-holding portion 24 of the base 20. A door 26 having a second hinge portion 32 is rotatably attached to the base 20, with the hinge first and second hinge portions 30, 32 forming a hinge 34. The door 26 is preferably shaped to conform to the shape of the blade-holding portion 24 of the base 20. A pair of lugs or tabs 38 are mounted in the blade holding portion 24 of the base 20, and are positioned to receive and position the razor blade 50 within the razor knife 10, such that the edge 52 of the razor blade 50 projects slightly below the blade-holding portion 24 of the base 20. Alternatively, the positioning lugs can be mounted in the door 26 (not shown), or additional lugs can be mounted in either blade-holding portion 24 of the base 20 or in the door 26 (not shown). The lugs 38 extend into corresponding recesses 36 formed on the interior side of the door 26 to secure the razor blade 50 when the door is closed. Mounted in both the blade-holding portion 24 of the base and the door 26 are a pair of magnets 40, 42, best seen in the elevational view of FIG. 2. The magnets 40, 42 are positioned such that when the door 26 is closed, as shown in the elevational view of FIG. 3, they are positioned adjacent to one another and attract each other magnetically to secure the door 26 in a closed position.

Various modifications can be made in the details of the various embodiments of the apparatus of the present invention, all within the scope and spirit of the invention as defined by the appended claims

1. A razor knife comprising:
a body including a handle portion and a blade carrier portion, a first hinge half formed between the handle portion and the blade carrier portion;
a door including a second hinge half formed at one end of the door portion, the door extending from the body the first hinge half and the second hinge half forming a hinge, the door being rotatable between an open position and a closed position;
at least one pair of magnets, a first magnet of the at least one pair being mounted in the blade carrier portion, and a corresponding second magnet of the at least one pair being mounted in the door, the first magnet and second magnet attracting each other when the door when the door is in the closed position.

2. A razor knife according to claim 1 further comprising at least one projection for securing a blade in the razor knife between the blade carrier portion and the door when the door is in the closed position.

3. A razor knife according to claim 2 wherein the at least one projection is formed in the blade carrier portion.

4. A razor knife according to claim 2 wherein the at least one projection is formed in the door or the blade carrier portion.
